(19) United States
(12) Patent Application Publication
(10) Pub. No.: US 2021/0309542 A1
(43) Pub. Date: Oct. 7, 2021

(54) WATER FILTRATION SYSTEM AND METHOD OF USE

(71) Applicant: Nimon Bondurant, Fayetteville, GA (US)

(72) Inventor: Nimon Bondurant, Fayetteville, GA (US)

(21) Appl. No.: 16/945,809

(22) Filed: Aug. 1, 2020

Related U.S. Application Data
(63) Continuation-in-part of application No. 16/841,682, filed on Apr. 7, 2020.

(51) Int. Cl. C02F 1/44; B01D 61/14; B01D 61/18; B01D 65/02; B01D 61/22; C02F 1/00

(52) U.S. Cl. CPC C02F 1/444; B01D 61/145; B01D 61/18; B01D 65/02; B01D 61/142; C02F 2103/001; C02F 1/008; C02F 2209/006; C02F 2209/03; C02F 2209/40; B01D 61/22

(57) ABSTRACT

Implementations of a water filtration system are provided. In some implementations, the water filtration system comprises a housing having a plurality of ports for receiving and outputting fluids wherein the housing encloses components configured to, in a filtration mode, filter water received through one of the plurality of ports to produce potable water and output the potable water through one of the plurality of ports and wherein the housing encloses components configured to, in a flush mode, use fluid received through one of the plurality of ports to remove contaminants captured in the water filtration system and output the contaminants through one of the plurality of ports.

### CROSS REFERENCE TO RELATED APPLICATION

This application claims the benefit of U.S. patent application Ser. No. 16/841,682, which was filed on Apr. 7, 2020, which claims the benefit of priority to 15/226,640, which was filed on Aug. 2, 2016, now U.S. Pat. No. 10,633,261, each of which is incorporated herein by reference in its entirety.

### TECHNICAL FIELD

This disclosure relates to implementations of a water filtration system and method of use.

### BACKGROUND

Clean water is one of the most basic necessities of human life, but, is unattainable for millions of people around the world. Surface water and ground water are being depleted and/ or contaminated thereby reducing freshwater water availability. Cisterns, structures designed to catch and store rainwater, are popular in areas where water is scarce. However, pathogens in cisterns is a huge problem. In the United States Virgin Islands (USVI) alone, over 98% of residences drink bottled water because the cisterns can contain protozoa, algae, bacteria, and viruses.

Current technology to filter water to prepare the water for human consumption utilize techniques such as membrane filtration, charcoal filtration, and filtration using ultraviolet light. These techniques all have shown to have deficiencies when utilized to clean water that is more polluted.

Charcoal filtration occurs as the water passes over the surface of charcoal. However, the pores of the charcoal can become saturated and when this occurs output water quality is reduced. Users are unable to determine when the charcoal has reached or begins to reach saturation and as such take the risk of utilizing systems using charcoal filtration.

Filtering water using ultraviolet light requires a power source, which makes this technique not a viable option in remote areas and third-world countries. Furthermore, ultraviolet light can be ineffective in eliminating biologics. Still further, as the turbidity and flow rate of water increases, the effectiveness of ultraviolet light filtration decreases.

### BRIEF DESCRIPTION OF THE DRAWINGS

FIGS. 1A and 1B illustrate example implementations of a water filtration system according to the present disclosure.

FIG. 2 illustrates an example water flow diagram of the water filtration system of FIG. 1A in a filtration mode.

FIG. 3 illustrates an example water flow diagram of the water filtration system of FIG. 1A in a flush mode.

FIG. 4 illustrates an implementation of an example environment for a water filtration system according to the present disclosure.

FIG. 5 illustrates an implementation of an example network environment for a water filtration system according to the present disclosure.

FIG. 6 illustrates an example computer system, which may be used with some implementations of the present invention.

### DETAILED DESCRIPTION

Implementations of a water filtration system are provided. In some implementations, the water filtration system comprises a housing having a plurality of ports for receiving and outputting fluids wherein the housing encloses components configured to, in a filtration mode, filter water received through one of the plurality of ports to produce potable water and output the potable water through one of the plurality of ports and wherein the housing encloses components configured to, in a flush mode, use fluid received through one of the plurality of ports to remove contaminants captured in the water filtration system and output the contaminants through one of the plurality of ports.

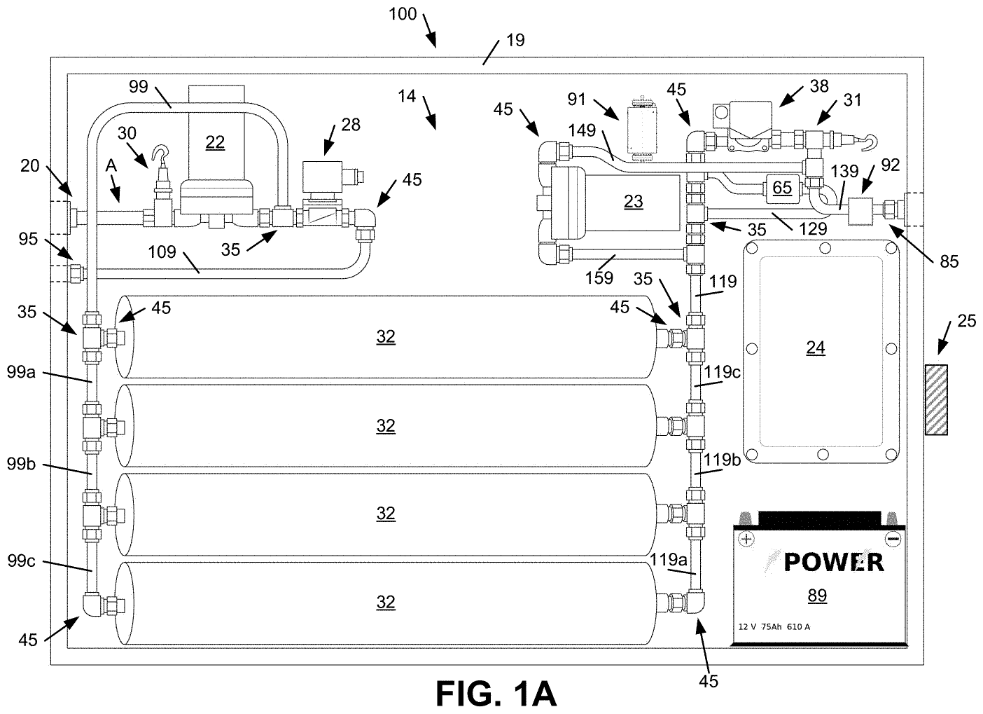

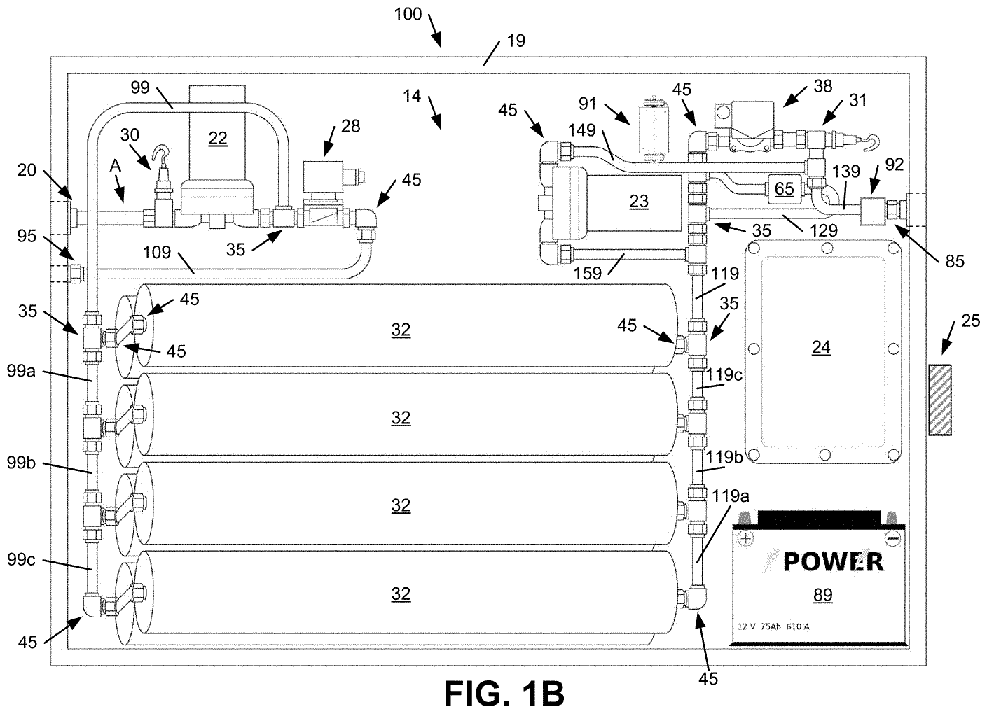

FIG. 1A illustrates an example implementation of a water filtration system 100 according to present disclosure. The water filtration system 100 comprises a housing 19 that stores and encloses components configured to remove contaminants from water introduced into the system to produce potable water in a filtration mode. The contaminants may be organic, inorganic, or biological contaminants. In some implementations, the houses 19 further stores and encloses components configured to remove contaminants captured in the water filtration system 100 in a flush mode.

In some implementations, the components may include a computer (e.g., microcomputer 24) configured to control other components within the housing such as pumps (e.g., components 22, 23, 91) and solenoids (e.g., components 28, 38) to automatically manage the filtration and flush modes.

In some implementations, the components may further comprise one or more sensors (e.g., components 30, 31, 65, 92) configured to detect and/or measure a physical property about the water passing through the water filtration system, the environment surrounding the water filtration system, or machine forces. In some implementations, the one or more sensors may record, indicate, and/or otherwise responds to the physical property. For example, in some implementations, the one or more sensors may measure or detect the water pressure, water quality, or rate of water flow. As yet another example, in some implementations, the one or more sensors may measure or detect external water source temperature, external water source level, geospatial stats (i.e., location data), air pressure, air temperature, humidity, or altitude.

In some implementations, the components may include a computer configured to perform predictive analytics based on sensor information to provide actionable insight directly impacting the machine and the water.

In some implementations, the components may include a computer configured to control a battery or other power source to provide power to internal electrical components in the water filtration system 100 in the event of a power outage.

The water filtration system 100 comprises a plurality of conventional or future developed hoses (e.g., components 99, 109, 119, 129, 139, 149, 159) and other plumbing apparatus (e.g., components 35, 45) that are operable to fluidly couple the elements thereof. In some implementations, a hose may comprise a plastic hose, metal plumbing, or any other apparatus including a pipe, tubing, conduit, or channel suitable for the transport of potable water. In some implementations, a hose or plumbing may be cooper, brass, or stainless steel.

The water filtration system 100 further comprises a plurality of fittings 45 and unions 35 releasably secured to the hoses and plumbing to facilitate the flow of fluid when the water filtration system 100 is in either a flush mode or filter mode. The unions 35 are manufactured from a suitable durable material and configured to couple a plurality of hoses so as to fluidly couple the elements as intended.

As shown in FIG. 1A, in some implementations, the water filtration system 100 comprises a contaminated water input port 20, an input pressure sensor 30, a filtration pump 22, a normally closed (NC) solenoid valve 28, a flush pump 23, a cleaning pump 91, a normally open (NO) solenoid valve 38, an output pressure sensor 31, a water quality sensor 65, a flow meter 92, a plurality of ultra-filtration modules 32; potable water output port 85, a flush mode output port 95, a primary power supply 25, a minicomputer 24, and a backup power source 89.

In some implementation, a water filtration system according to present disclosure comprises a combination of one or more of the above components.

The filtration pump 22, flush pump 23, NC solenoid valve 28, and NO solenoid valve 38 are operably coupled to a power supply 25 and minicomputer 24. In some implementations, the power supply 25 may have a power input connection and one or more power output connections. The power input connection may receive energy in the form of electric current from a power source such as an electrical outlet, energy storage devices such as batteries or fuel cells, generators or alternators, solar power converters, or another power supply. The one or more power output connections deliver current to the load (e.g., the filtration pump 22, flush pump 23, solenoid valve 28, and/or solenoid valve 38). In some implementations, the power source may be an on-board DC power source such as a battery. In some implementations, the minicomputer 24 is a single board computer intermediate to the power source and configured to control electrical components operably coupled to the power supply 25 and minicomputer 24.

In some implementations, input port 20 comprises an opening therethrough and is secured to the housing 19 at a location having an opening therethrough such that the opening in the input port 20 and the opening in the housing 19 align so that fluid from the outside of the water filtration system 100 may enter the interior 14 of the water filtration system 100 during the filtration mode. In some implementations, a hose is releasably secured to the input port 20. The input port 20 is manufactured from any suitable durable material such as, but not limited to, plastic, copper, or stainless steel.

In some implementations, the input pressure sensor 30 is fluidly connected to the input port 20 and configured to measure the water pressure of the water entering the water filtration system 100. The input pressure sensor 30 is operably coupled to the minicomputer 24, which receives and stores the water pressure measured by the input pressure sensor 30.

The filtration pump 22 comprises a first port and a second port. The first port of the filtration pump 22 is fluidly connected to the input port 20. In some implementations, as shown in FIG. 1A, the input pressure sensor 30 is disposed between the input port 20 and the filtration pump 22. The second port of the filtration pump 22 is fluidly connected to the NC solenoid valve 28 and a plurality of ultra-filtration modules 32 via a series of unions 35 as shown in FIG. 1A. In some implementations, the filtration pump 22 may be a conventional bypass fluid pump that is configured to pump fluid in a desired direction in the water filtration system 100. As mentioned above, the pump 22 is operably coupled to the power supply 25 via the minicomputer 24, which controls the operation of the pump 22.

The NC solenoid valve 28 comprises a first port and a second port. As discussed above, the first port of the NC solenoid valve 28 is fluidly connected to the second port of pump 22 via a union 35 as shown. The second port of the NC solenoid valve 28 is fluidly connected to the flush mode output port 95. In some implementations, the NC solenoid valve 28 is a conventional solenoid valve that is configured to control the direction of fluid within the water filtration system 100 when operated in a filtration mode and a flush mode. As mentioned above, the solenoid valve 28 is operably coupled to the power supply 25 via the minicomputer 24, which controls the operation of the solenoid valve 28.

In some implementations, each of the ultra-filtration modules 32 comprise an outer casing having a first port and a second port. As shown in FIG. 1A, the first port of the ultra-filtration modules 32 are fluidly connected serially such that the fluid from the hose 99 is divided into separate flow paths to the first port of the ultra-filtration modules 32 via a series of unions 35, fittings 45, and hoses 99a, 99b, 99c.

The first port of each of the ultra-filtration modules 32 is fluidly coupled to the second port of the pump 28. The second port of each of the ultra-filtration modules 32 is fluidly coupled to the potable water output port 85 via a filtration mode path and a flush mode path as discussed in more detail below.

In some implementations, each of the ultra-filtration modules 32 comprises a filtration material or membrane having a pore size ranging from 0.01 microns to 0.02 microns housed in the casing. In some implementations, the pore size is less than 0.01 microns. In some implementations, the pore size is greater than 0.02 microns.

In some implementations, the ultra-filtration modules 32 may be a tubular module design. In some implementations, each of the ultra-filtration modules 32 is 4 inches in diameter and 21 inches long. In some implementations, the diameter of each module 32 is greater than 4 inches. In some implementations, the diameter of each module 32 is less than 4 inches. In some implementations, the length of each module is greater than 21 inches long. In some implementations, the length of each module is less than 21 inches long. In some implementations, the ultra-filtration modules 32 may be any suitable design.

In some implementations, the size and number of the ultra-filtration modules 32 may be any suitable number and size. FIG. 1A illustrates a system with four ultra-filtration modules 32. FIG. 1B illustrates a system with eight ultra-filtration modules 32.

In some implementations, the ultra-filtration modules 32 may be replaced with any filtration or purification apparatus or system known or future-developed to achieve a filtration or purification goal.

As shown in FIG. 1A, in some implementations, the second port of the ultra-filtration modules 32 are fluidly connected serially such that the fluid output from the second port of the ultra-filtration modules 32 during a filtration mode converges into a single hose 118 via a series of fittings 45, unions 35, and hoses 119a, 119b, 119c. During a flush mode, the fluid in hose 119 is directed towards the second port for the ultra-filtration modules 32 via the series of fittings 45 and unions 35 as shown in FIG. 1A.

In some implementations, as shown in FIG. 1A, the NO solenoid valve 38, the output pressure sensor 31, and the flow meter 92 is disposed between the converged output of the second port of the ultra-filtration modules 32 and the potable water output port 85.

In some implementations, the converged output of the second port of the ultra-filtration modules 32 is split into two separate streams by union 35 as shown in FIG. 1A. The first stream is directed to the NO solenoid valve 38 and the second stream is directed to the water quality sensor 65 via hose 129. The stream directed to the water quality sensor 65 is converged back with the stream directed to the NO solenoid valve 38 after passing through the water quality sensor 65. The water quality sensor 65 is configured to measure water quality indicia such as COD (chemical oxygen demand), TOC (total organic carbon), Turbidity, UV254, and salinity. In some implementations, the water quality sensor 65 is a multispectral water quality detection device (e.g., a sonde device). The water quality sensor 65 is operably coupled to the minicomputer 24, which receives and stores the information measured by the water quality sensor 65.

The NO solenoid valve 38 comprises a first port and a second port. The first port of the NO solenoid valve 38 is fluidly connected to the converged output of the second port of the ultra-filtration modules 32. The second port of the NO solenoid valve 38 is fluidly connected to the potable water output port 85. In some implementations, the NO solenoid valve 38 is a conventional solenoid valve that is configured to control the direction of fluid within the water filtration system 100 when operated in a filtration mode and a flush mode. As mentioned above, the NO solenoid valve 38 is operably coupled to the power supply 25 via the minicomputer 24, which controls the operation of the solenoid valve 38.

In some implementations, the output pressure sensor 31 is disposed between the second port of the NO solenoid valve 38 and the potable water output port 85 and configured to measure the water pressure of the water exiting the water filtration system 100. More specifically, in some implementations, a first port of the output pressure sensor 31 is fluidly coupled to the second port of the NO solenoid valve 38 and the second port of the output pressure sensor 31 is fluidly coupled to the potable water output port 85. The output pressure sensor 31 is operably coupled to the minicomputer 24, which receives and stores the water pressure measured by the output pressure sensor 31.

In some implementations, the flow meter 92 is configured to measure the rate of water flow and is disposed between the second port of the output pressure sensor 31 and the potable water output port 85. More specifically, in some implementations, a first port of the flow meter 92 is fluidly coupled to the second port of the output pressure sensor 31 and the second port of the flow meter 92 is fluidly coupled to the potable water output port 85. In some implementations, the flow meter 92 is a hall effect flow meter. The flow meter 92 is operably coupled to the minicomputer 24, which receives and stores the rate of water flow measured by the output pressure sensor 31.

The potable water output port 85 comprises an opening therethrough and is secured to the housing 19 at a location having an opening therethrough such that the opening in the potable water output port 85 and the opening in the housing 19 align so that fluid from the interior 14 of the water filtration system 100 may exit the water filtration system 100 after filtration and so that fluid from the outside of the water filtration system 100 may enter the interior 14 of the water filtration system 100 during the flush mode. Potable water output port 85 is a manufactured from any suitable durable material such as, but not limited to, plastic, copper, or stainless steel.

The flush pump 23 comprises a first port and a second port. The first port of the flush pump 23 is fluidly connected to the potable water output port 85. The second port of the flush pump 23 is fluidly connected to the second port of the ultra-filtration modules 32 via the series of fittings 45, unions 35, and hoses 119c, 119b, 119a discussed above and as shown in FIG. 1A. In some implementations, the flush pump 23 may be a conventional fluid pump that is configured to pump fluid in a desired direction in a flush mode. As mentioned above, the pump 23 is operably coupled to the power supply 25 via the minicomputer 24, which controls the operation of the pump 23.

In some implementations, a cleaning pump 91 is fluidly coupled to the flush path and configured to dispense chemical/non-chemical membrane cleaning agents into the flush stream. In some implementation, the cleaning pump 91 is positioned along the flush path prior to flush pump 23 as shown in FIG. 1A. The cleaning pump 91 is operably coupled the minicomputer 24, which controls the operation of the cleaning pump 91. In some implementations, the cleaning pump 91 is activated once every three months for thirty seconds. In some implementations, the cleaning pump 91 is activated once every six months for thirty seconds. In some implementations, the cleaning pump 91 is activated more frequently than once every three months. In some implementations, the cleaning pump 91 is activated less frequently than once every three months and more frequently than once every six months. In some implementations, the cleaning pump 91 when activated operates for less than 30 seconds. In some implementations, the cleaning pump 91 when activated operates for more than 30 seconds.

In some implementations, the backup power source 89 is a battery. In some implementations, the backup power source 89 is a rechargeable battery. In some implementations, the backup power source 89 is a lithium-ion battery 89. The backup power source 89 is operably coupled the minicomputer 24, which controls the operation of the backup power source 89. In some implementations, the backup power source 89 is configured to provide power to internal electrical components in the event of a primary source power failure.

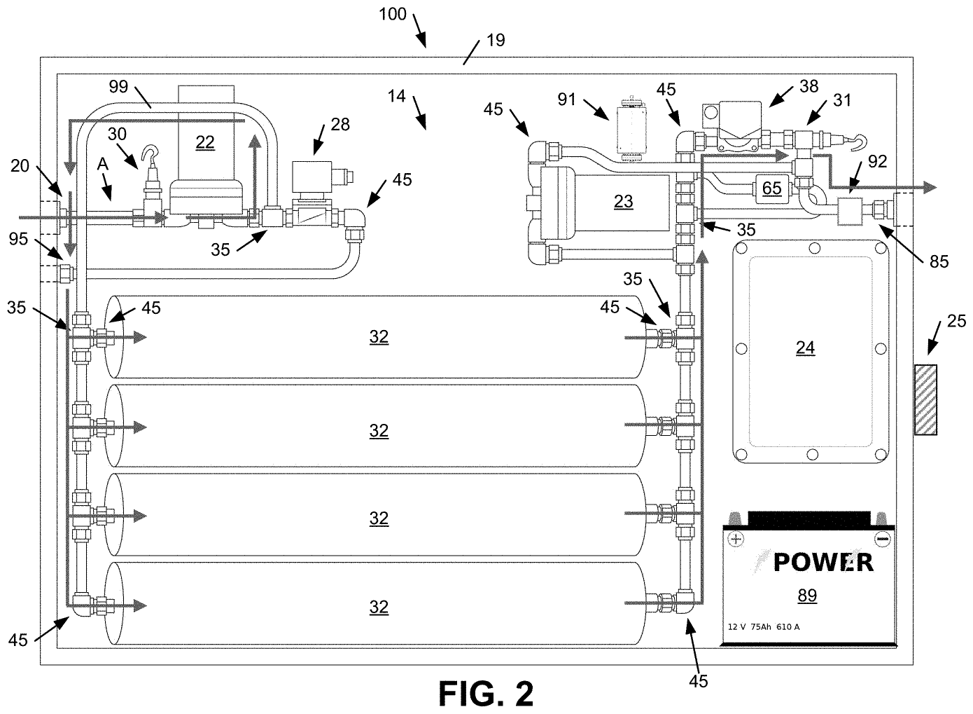

FIG. 2 illustrates an example water flow diagram of the water filtration system 100 in a filtration mode. The path of the water flow in the water filtration system 100 in the filtration mode or a portion thereof is a filtration mode path. The directional arrows in FIG. 2 illustrates the water flow direction in the filtration mode.

In the filtration mode, solenoid valve 28 is closed, solenoid valve 38 is open, and pump 23 is passive/ off. In some implementations, to use the water filtration system 100 in the filtration mode, plumbing is secured to the potable water output port 85. Furthermore, the power supply 25 is used to supply power to the water filtration system 100 from a power source (e.g., an electrical outlet, energy storage devices such as batteries or fuel cells, generators or alternators, solar power converters, or another power supply). One end of a hose is attached to the water input port 20 and the opposite end of the hose is inserted into or fluidly connected a water source to be filtered (e.g., a cistern). In this configuration, the pressure from the plumbing will draw the water into and through the water filtration system 100 as indicated by the directional arrows. However, if minicomputer 24 detects that the water pressure has fallen below a predetermined level (as measured by sensor 31) or detects a lack of sufficient power from the power supply 25, minicomputer 24 activates pump 22 to draw water into and through the water filtration system 100. In some implementations, when the water pressure measured at output pressure sensor 31 is less than the water pressure measured at input pressure sensor 30, minicomputer 24 activates pump 22 until the water pressure measured at output pressure sensor 31 equals than the water pressure measured at input pressure sensor 30.

As water enters the water filtration system 100, the input pressure sensor 30 measures the input water pressure and transmits the measurement to the minicomputer 24 for storage. The water flows through pump 22, and solenoid valve 28, which is closed, redirects the water through hose 99 towards the first port ultra-filtration modules 32. The water is divided by the series of unions 35, fittings 45, and hoses 99a, 99b, 99c to the first port of the ultra-filtration modules 32.

The ultra-filtration modules 32 filters the water and the water then exits the second port of the ultra-filtration modules 32. The water output from the second port of the ultra-filtration modules 32 converges into hose 119 by the series of fittings 45, unions 35, and hoses 119a, 119b, 119c.

The water then splits into two streams by a union 35. As discussed above, the first stream is directed to the solenoid valve 38 and the second stream is directed to the water quality sensor 65 via hose 129. The stream directed to the water quality sensor 65 is converged back with the stream directed to the NO solenoid valve 38 after passing through the water quality sensor 65. The water quality sensor 65 measures the water quality and transmits the measurements to the minicomputer 24 for storage.

The water then flows through solenoid valve 38, which is open, the output pressure sensor 31 (which measures the output water pressure), and the flow meter 92 (which measures the water flow rate) as it exits the water filtration system 100 through potable water output port 85. The output pressure sensor 31 and the flow meter 92 each transmits their measurements to the minicomputer 24 for storage.

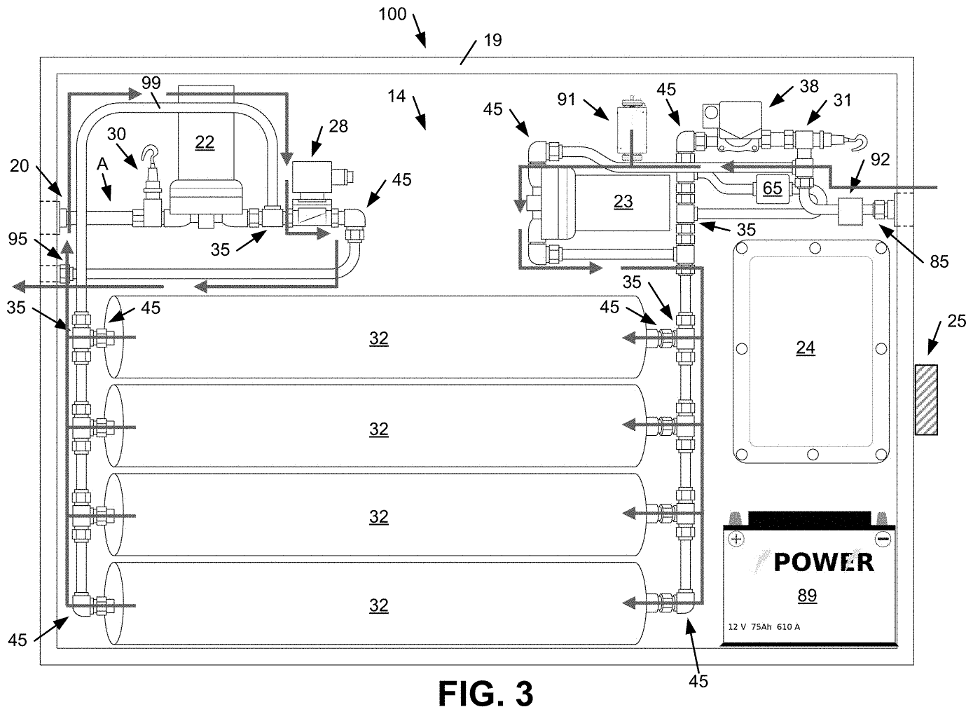

FIG. 3 illustrates an example water flow diagram of the water filtration system 100 in a flush mode. The path of the water flow in the water filtration system 100 in the flush mode or a portion thereof is a flush mode path. The directional arrows in FIG. 3 illustrates the water flow direction in the filtration mode.

In the flush mode, contaminants captured in the water filtration system 100 are removed from the system. The flush mode can be activated as desired by a user (e.g., via a mobile application), automatically at predetermined times as scheduled by minicomputer 24, or automatically during predetermined conditions as determined by the minicomputer 24. In the flush mode, the minicomputer 24 opens solenoid valve 28, closes solenoid valve 38, and turn on pump 23. Pump 22 remain passive unless conditions discussed above causes minicomputer 24 to activates pump 22.

In some implementations, to use the water filtration system 100 in the flush mode, fluid (e.g., water and/or cleaning solution) is introduced into the water filtration system 100 at potable water output port 85. In some implementations, water stored in a tank operatively connected to the water output port 85 is introduced into the water filtration system 100.

Pump 23 will draw the fluid into and through the water filtration system 100 as indicated by the directional arrows.

As fluid enters the water filtration system 100, the flow meter 92 measures the flow rate and transmits the measurement to the minicomputer 24 for storage. The flow meter informs how much water is being used and can be used to detect leaks. Solenoid valve 38, which is closed, redirects the fluid through hose 149 towards pump 23. Cleaning pump 91 may dispense a chemical/non-chemical membrane cleaning solution into the flush stream. The fluid flows through pump 23, tube 159, and tube 111 towards the first port ultra-filtration modules 32. The fluid is divided by the series of unions 35, fittings 45, and hoses 119c, 119b, 119a to the second port of the ultra-filtration modules 32.

The fluid passes through the ultra-filtration modules 32 picking up contaminants and then exits the first port of the ultra-filtration modules 32. The fluid output from the first port of the ultra-filtration modules 32 converges into hose 99 by the series of fittings 45, unions 35, and hoses 99c, 99b, 99a.

The fluid then flows through solenoid valve 28, which is open, hose 109, and exits the water filtration system 100 through flush mode output port 95.

In some implementations, the flush mode is activated automatically once a day for 45 seconds. In some implementations, the flush mode is activated automatically less frequently than once a day for 45 seconds. In some implementations, the flush mode is activated automatically more frequently than once a day for 45 seconds. In some implementations, when the flush mode is activated, it operates for less than 45 seconds. In some implementations, when the flush mode is activated, it operates for more than 45 seconds.

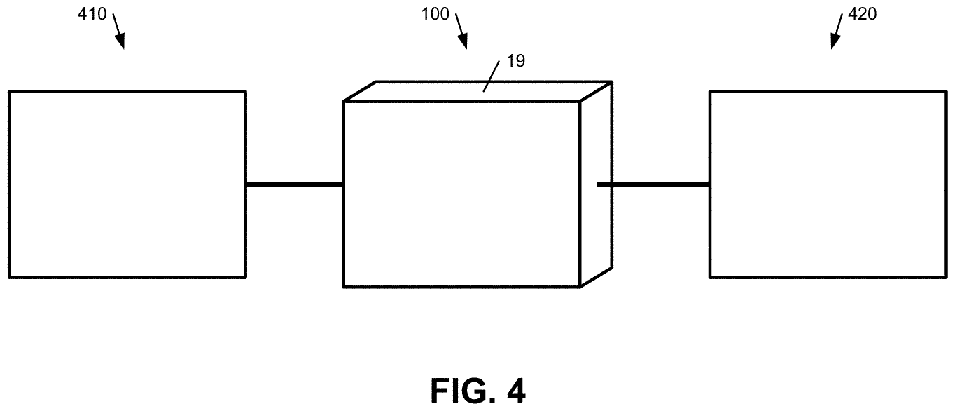

As shown in FIG. 4, in some implementations, the water filtration system 100 is fluidly connected between a water source 410 to be filtered and a building 420 (e.g., a residential or commercial building). In some implementations, the water source 410 is a cistern. In some implementations, the water filtration system 100 is fluidly connected to the main water input to the building 420. In some implementations, the housing 19 of the water filtration system 100 is 20 inches in height, 42 inches in length, and 6 inches in width. In some implementations, the housing 19 of the water filtration system 100 is 20 inches in height, 42 inches in length, and 12 inches in width. In some implementations, the housing is less than 40 inches in height, less than 82 inches in length, and less than 24 inches in width.

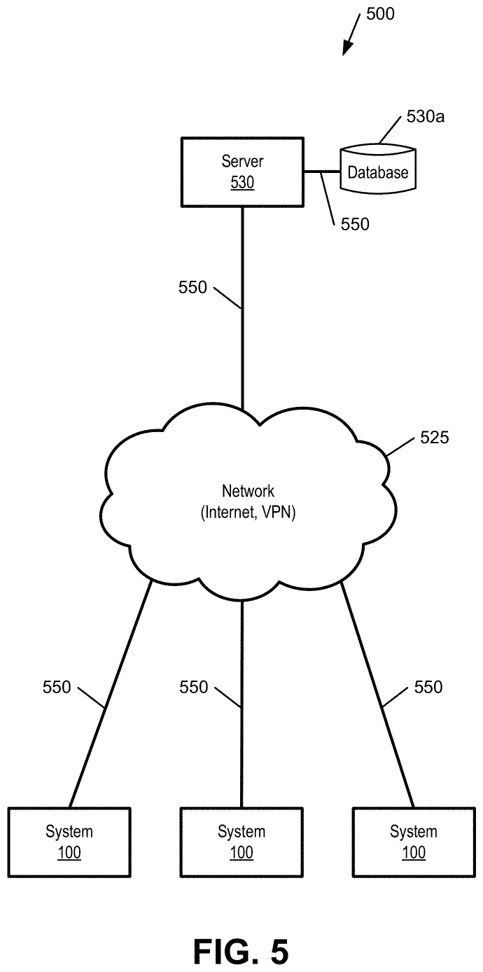

FIG. 5 illustrates an implementation of an example network environment of a water filtration system 100 according to the present disclosure.

As shown in FIG. 5, in some implementations, the environment 500 may include one or more water filtration systems 100, network 525, and one or more servers 530. In some implementations, the environment 500 may also include one or more data storages 530 linked to the servers 530.

As discussed above, the minicomputer 24 of the water filtration systems 100 stores water pressure measurements, water quality measurements, water flow rates, etc. In some implementations, the server 530 may receive this information collected and stored by the water filtration systems 100 via network 525. In some implementations, the received information is stored in a database 530a of the server 530.

In some implementations, the water filtration systems 100 are configured to access network 525. In some implementations, the water filtration systems 100 are configured to communicate with servers 530.

In some implementations, components of the environment 500 may communicate with any other component of the environment 500 over network 525. Network 525 may be any suitable network. In some implementations, for example, one or more portions of network 525 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 525, or a combination of two or more of the foregoing.

In some embodiments, components of the environment 500 may be configured to communicate over links 550. Links 550 may connect components of the environment 500 to network 525 or to each other. In some implementations, one or more links 550 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 550. Links 550 may not be the same throughout the environment 500.

In some implementations, the server devices 530 may include a processor, memory, user accounts, and one or more modules to perform various functions as any described above.

In some implementations, each server 530 may be a unitary server or may be a distributed server spanning multiple computers or multiple datacenters. Servers 530 may be of various types, such as, for example and without limitation, web server, file server, application server, exchange server, database server, or proxy server. In some implementations, each server 530 may include hardware, software, or embedded logic components or a combination of two or more such components for carrying out the appropriate functionalities implemented or supported by server 530. A database server is generally capable of providing an interface for managing data stored in one or more data stores.

In some implementations, one or more data storages 530a may be communicatively linked to one or more servers 530, respectively, via one or more links 550. In some implementations, data storages 530a may be used to store various types of information. In some implementations, the information stored in data storages 530a may be organized according to specific data structures. In particular embodiment, each data storage 530a may be a relational database. Particular embodiments may provide interfaces that enable servers 530 or water filtration systems 100 to manage, e.g., retrieve, modify, add, or delete, the information stored in data storage 530a.

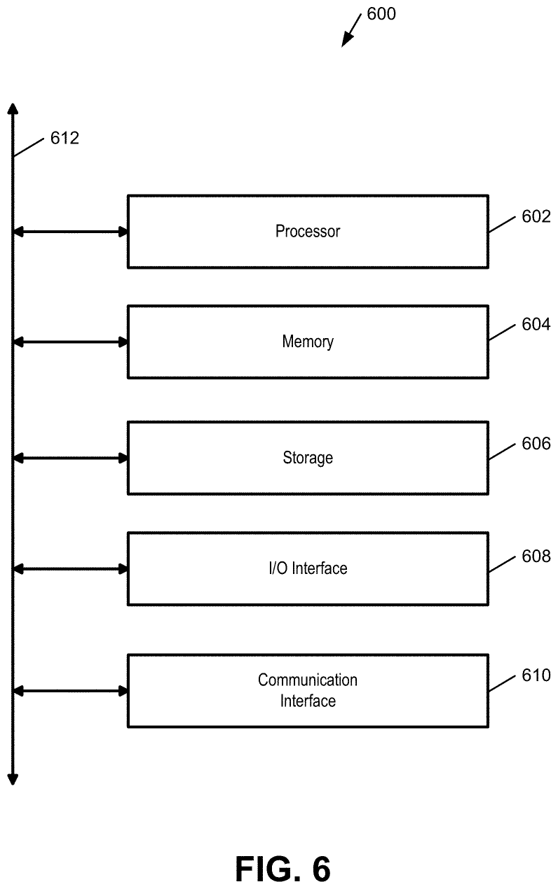

FIG. 6 illustrates an example computer system 600, which may be used with some implementations of the present invention. For example, this disclosure discloses a microcomputer 24 and server 530, each of which may take the form of computer system 600 described below. This disclosure contemplates any suitable number of computer systems 600.

This disclosure contemplates computer system 600 taking any suitable physical form. In some implementations, as an example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 600 may include one or more computer systems 600; be unitary or distributed; span multiple locations; span multiple machines; or reside in a cloud, which may include one or more cloud components in one or more networks.

In some implementations, where appropriate, one or more computer systems 600 may perform without substantial spatial or temporal limitation one or more steps of one or more methods described or illustrated herein. In some implementations, as an example and not by way of limitation, one or more computer systems 600 may perform in real time or in batch mode one or more steps of one or more methods described or illustrated herein. In some implementations, one or more computer systems 600 may perform at different times or at different locations one or more steps of one or more methods described or illustrated herein, where appropriate.

In some implementations, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In some implementations, processor 602 includes hardware for executing instructions, such as those making up a computer program. In some implementations, as an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606.

In some implementations, processor 602 may include one or more internal caches for data, instructions, or addresses. The present disclosure contemplates processor 602 including any suitable number of any suitable internal caches, where appropriate. In some implementations, as an example and not by way of limitation, processor 602 may include one or more instruction caches, one or more data caches, and one or more translation look-aside buffers (TLBs).

In some implementations, instructions in the instruction caches may be copies of instructions in memory 604 or storage 606, and the instruction caches may speed up retrieval of those instructions by processor 602.

In some implementations, data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data.

In some implementations, the data caches may speed up read or write operations by processor 602. In some implementations, the TLBs may speed up virtual-address translation for processor 602.

In some implementations, processor 602 may include one or more internal registers for data, instructions, or addresses. The present disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In some implementations, memory 604 includes main memory for storing instructions for processor 602 to execute or data for processor 602 to operate on. In some implementations, as an example and not by way of limitation, computer system 600 may load instructions from storage 606 or another source (such as, for example, another computer system 600) to memory 604.

In some implementations, processor 602 may then load the instructions from memory 604 to an internal register or internal cache. In some implementations, to execute the instructions, processor 602 may retrieve the instructions from the internal register or internal cache and decode them.

In some implementations, during or after execution of the instructions, processor 602 may write one or more results (which may be intermediate or final results) to the internal register or internal cache. In some implementations, processor 602 may then write one or more of those results to memory 604.

In some implementations, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere).

In some implementations, one or more memory buses (which may each include an address bus and a data bus) may couple processor 602 to memory 604. In some implementations, bus 612 may include one or more memory buses, as described below.

In some implementations, one or more memory management units (MMUs) reside between processor 602 and memory 604 and facilitate accesses to memory 604 requested by processor 602.

In some implementations, memory 604 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 604 may include one or more memories 604, where appropriate. Although this disclosure describes and illustrates particular memory, this disclosure contemplates any suitable memory.

In some implementations, storage 606 includes mass storage for data or instructions. In some implementations, as an example and not by way of limitation, storage 606 may include an HDD, a floppy disk drive, flash memory, an optical disc, a magneto-optical disc, magnetic tape, or a Universal Serial Bus (USB) drive or a combination of two or more of these.

In some implementations, storage 606 may include removable or non-removable (or fixed) media, where appropriate. In some implementations, storage 606 may be internal or external to computer system 600, where appropriate. In some implementations, storage 606 is non-volatile, solid-state memory.

In some implementations, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form.

In some implementations, storage 606 may include one or more storage control units facilitating communication between processor 602 and storage 606, where appropriate. In some implementations, where appropriate, storage 606 may include one or more storages 606. Although this disclosure describes and illustrates particular storage, this disclosure contemplates any suitable storage.

In some implementations, I/O interface 608 includes hardware, software, or both providing one or more interfaces for communication between computer system 600 and one or more I/O devices. In some implementations, computer system 600 may include one or more of these I/O devices, where appropriate.

In some implementations, one or more of these I/O devices may enable communication between a person and computer system 600. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 608 for them.

In some implementations, where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In some implementations, communication interface 610 includes hardware, software, or both providing one or more interfaces for communication (such as, for example, packet-based communication) between computer system 600 and one or more other computer systems 600 or one or more networks.

In some implementations, as an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it.

In some implementations, as an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 600 may include any suitable communication interface 610 for any of these networks, where appropriate. In some implementations, communication interface 610 may include one or more communication interfaces 610, where appropriate. Although this disclosure describes and illustrates a particular communication interface, this disclosure contemplates any suitable communication interface.

In some implementations, bus 612 includes hardware, software, or both coupling components of computer system 600 to each other. In some implementations, as an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 612 may include one or more buses 612, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 602 (such as, for example, one or more internal registers or caches), one or more portions of memory 604, one or more portions of storage 606, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The figures, including any photographs and drawings, comprised herewith may represent one or more implementations of a water filtration system or environment thereof.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A water filtration system comprising:
a housing having a plurality of ports for receiving and outputting fluids wherein the housing encloses components configured to, in a filtration mode, filter water received through one of the plurality of ports to produce potable water and output the potable water through one of the plurality of ports and wherein the housing encloses components configured to, in a flush mode, use fluid received through one of the plurality of ports to remove contaminants captured in the water filtration system and output the contaminants through one of the plurality of ports wherein the components comprise:
a plurality of ultra-filtration modules wherein each of the plurality of ultra-filtration modules comprises a first port and a second port and a filtration membrane therebetween and wherein each of the ultra-filtration modules is fluidly coupled to the plurality of ports;
wherein in the filtration mode, the water filtration system is configured to receive water through a first one of the plurality of ports and direct the water received through the first one of the plurality of ports to the first port of each of the plurality of filters wherein each of the plurality of filters is configured to output the water received at the first port through the second port and the water filtration system is configured to output the water from second port through a second one of the plurality of ports and wherein in the flush mode, the water filtration system is configured to receive fluid through a third one of the plurality of ports and direct the fluid to the second port of each of the plurality of filters wherein each of the plurality of filters is configured to output the fluid received at the second port through the first port and the water filtration system is configured to output the fluid from the first port through a fourth one of the plurality of ports.

2. The water filtration system of claim 1 further comprising a first conduit having a first end and a second end wherein the first end of the first conduit is fluidly coupled to the first one of the plurality of ports and the second end of the first conduit is fluidly coupled to the first port of each of the plurality of filters and a second conduit having a first end and a second end wherein the first end of the second conduit is fluidly coupled to the second one of the plurality of ports and the second end of the second conduit is fluidly coupled the second port of each of the plurality of filters.

3. The water filtration system of claim 2 further comprises a flush pump having a first port and second port wherein the first port of the flush pump is fluidly connected to the third one of the plurality of ports and the second port of the flush pump is fluidly connected to the second port of each of the ultra-filtration modules via the second conduit wherein the water filtration system is configured to activate the flush pump in the flush mode to pump fluid into the water filtration system through the third one of the plurality of ports and then through the second conduit to the second port of each of the ultra-filtration modules and then through the first port of each of the ultra-filtration modules and through the first conduit and out of the water filtration system through the fourth one of the plurality of ports.

4. The water filtration system of claim 3 further comprises a filtration pump having a first port and second port wherein the first port of the filtration pump is fluidly connected to the first one of the plurality of ports and the second port of the flush pump is fluidly connected to the first port of each of the ultra-filtration modules via the first conduit wherein the water filtration system is configured to activate the filtration pump in the filtration mode to pump fluid into the water filtration system through the first one of the plurality of ports and then through the first conduit to the first port of each of the ultra-filtration modules and then through the second port of each of the ultra-filtration modules and through the second conduit and out of the water filtration system through the second one of the plurality of ports.

5. The water filtration system of claim 4 further comprising a non-transitory computer readable medium containing instructions that, when executed by a processor on a first computing device, cause the computing device to activate the flush pump during a flush mode and activate the filtration pump during a filtration mode.

6. The water filtration system of claim 5 further comprising an input pressure sensor fluidly connected to the first one of the plurality of ports and configured to measure the water pressure of the water entering the water filtration system through first one of the plurality of ports.

7. The water filtration system of claim 6 further comprising an output pressure sensor fluidly connected to the second one of the plurality of ports and configured to measure the water pressure of the water exiting the water filtration system through second one of the plurality of ports.

8. The water filtration system of claim 7 further comprising a water quality sensor fluidly connected to the second one of the plurality of ports and configured to measure an indicia of the water quality of the water exiting the water filtration system through second one of the plurality of ports.

9. The water filtration system of claim 8 further comprising a flow meter fluidly connected to the second one of the plurality of ports and configured to measure the rate of water flow of the water exiting the water filtration system through second one of the plurality of ports.

10. The water filtration system of claim 9 wherein the input pressure sensor, the output pressure sensor, the water quality sensor, and the flow meter are operably coupled to the first computing device wherein the input pressure sensor, output pressor sensor, the water quality sensor, and the flow meter are configured to transmit their respective measurements to the computing device and the first computing device is configured to store the measurement.

11. The water filtration system of claim 10 wherein the non-transitory computer readable medium containing further instructions that, when executed by the processor on the first computing device, cause the first computing device to send the stored measurements over a network to a second computing device.

12. The water filtration system of claim 1 wherein the second one of the plurality of ports and third one of the plurality of ports are the same port.

13. The water filtration system of claim 1 wherein the housing is less than 40 inches in height, less than 82 inches in length, and less than 24 inches in width.

14. The water filtration system of claim 1 further comprising a primary power source and a backup power source wherein the backup power source is a battery.

15. A water filtration system comprising:
a housing having a plurality of ports for receiving and outputting fluids wherein the housing encloses components configured to, in a filtration mode, filter water received through one of the plurality of ports to produce potable water and output the potable water through one of the plurality of ports and wherein the housing encloses components configured to, in a flush mode, use fluid received through one of the plurality of ports to remove contaminants captured in the water filtration system and output the contaminants through one of the plurality of ports wherein the components comprise:
a plurality of ultra-filtration modules wherein each of the plurality of ultra-filtration modules comprises a first port and a second port and a filtration membrane therebetween and wherein each of the ultra-filtration modules is fluidly coupled to the plurality of ports wherein in the filtration mode, the water filtration system is configured to receive water through a first one of the plurality of ports and direct the water received through the first one of the plurality of ports to the first port of each of the plurality of filters wherein each of the plurality of filters is configured to output the water received at the first port through the second port and the water filtration system is configured to output the water from second port through a second one of the plurality of ports and wherein in the flush mode, the water filtration system is configured to receive fluid through a third one of the plurality of ports and direct the fluid to the second port of each of the plurality of filters wherein each of the plurality of filters is configured to output the fluid received at the second port through the first port and the water filtration system is configured to output the fluid from first port through a fourth one of the plurality of ports;
a first conduit having a first end and a second end wherein the first end of the first conduit is fluidly coupled to the first one of the plurality of ports and the second end of the first conduit is fluidly coupled the first port of each of the plurality of filters and a second conduit having a first end and a second end wherein the first end of the second conduit is fluidly coupled to the second one of the plurality of ports and the second end of the second conduit is fluidly coupled the second port of each of the plurality of filters;
a flush pump having a first port and second port wherein the first port of the flush pump is fluidly connected to the third one of the plurality of ports and the second port of the flush pump is fluidly connected to the second port of each of the ultra-filtration modules via the second conduit wherein the water filtration system is configured to activate the flush pump in the flush mode to pump fluid into the water filtration system through the third one of the plurality of ports and then through the second conduit to the second port of each of the ultra-filtration modules and then through the first port of each of the ultra-filtration modules and through the first conduit and out of the water filtration system through the fourth one of the plurality of ports;
a filtration pump having a first port and second port wherein the first port of the filtration pump is fluidly connected to the first one of the plurality of ports and the second port of the flush pump is fluidly connected to the first port of each of the ultra-filtration modules via the first conduit wherein the water filtration system is configured to activate the filtration pump in the filtration mode to pump fluid into the water filtration system through the first one of the plurality of ports and then through the first conduit to the first port of each of the ultra-filtration modules and then through the second port of each of the ultra-filtration modules and through the second conduit and out of the water filtration system through the second one of the plurality of ports;
a non-transitory computer readable medium containing instructions that, when executed by a processor on a first computing device, cause the computing device to activate the flush pump during a flush mode and activate the filtration pump during a filtration mode;
an input pressure sensor fluidly connected to the first one of the plurality of ports and configured to measure the water pressure of the water entering the water filtration system through first one of the plurality of ports;
an output pressure sensor fluidly connected to the second one of the plurality of ports and configured to measure the water pressure of the water exiting the water filtration system through second one of the plurality of ports;
a water quality sensor fluidly connected to the second one of the plurality of ports and configured to measure an indicia of the water quality of the water exiting the water filtration system through second one of the plurality of ports; and
a flow meter fluidly connected to the second one of the plurality of ports and configured to measure the rate of water flow of the water exiting the water filtration system through second one of the plurality of ports;
wherein the input pressure sensor, the output pressure sensor, the water quality sensor, and the flow meter are operably coupled to the first computing device wherein the input pressure sensor, output pressor sensor, the water quality sensor, and the flow meter are configured to transmit their respective measurements to the computing device and the first computing device is configured to store the measurement; and
wherein the non-transitory computer readable medium containing further instructions that, when executed by the processor on the first computing device, cause the first computing device to send the stored measurements over a network to a second computing device.

16. A water filtration system comprising:
a housing fluidly connected between a cistern and a main water input to a building having plumbing wherein the housing comprises a plurality of ports for receiving and outputting fluids wherein the housing encloses components configured to, in a filtration mode, filter water from the cistern received through one of the plurality of ports to produce potable water and output the potable water through one of the plurality of ports and to the main water input and then through the plumbing of the building and wherein the housing encloses components configured to, in a flush mode, use fluid received through one of the plurality of ports to remove contaminants captured in the water filtration system and output the contaminants through one of the plurality of ports wherein the components comprise:
a plurality of ultra-filtration modules wherein each of the plurality of ultra-filtration modules comprises a first port and a second port and a filtration membrane therebetween and wherein each of the ultra-filtration modules is fluidly coupled to the plurality of ports;
wherein in the filtration mode, the water filtration system is configured to receive water through a first one of the plurality of ports and direct the water received through the first one of the plurality of ports to the first port of each of the plurality of filters wherein each of the plurality of filters is configured to output the water received at the first port through the second port and the water filtration system is configured to output the water from second port through a second one of the plurality of ports and
wherein in the flush mode, the water filtration system is configured to receive fluid through a third one of the plurality of ports and direct the fluid to the second port of each of the plurality of filters wherein each of the plurality of filters is configured to output the fluid received at the second port through the first port and the water filtration system is configured to output the fluid from the first port through a fourth one of the plurality of ports.

17. The water filtration system of claim 16 wherein the housing is less than 40 inches in height, less than 82 inches in length, and less than 24 inches in width.

18. A method of using the water filtration system of claim 16 comprising:
filtering water from a cistern using the components in the housing in the water filtration system; and
using the water output from the housing and the plumbing in the building for human consumption.

19. A method of using the water filtration system of claim 17 comprising:
filtering water from a cistern using the components in the housing in the water filtration system; and
using the water output from the housing and the plumbing in the building for human consumption.
